(19) United States
(12) Patent Application Publication
(10) Pub. No.: US 2011/0144270 A1
(43) Pub. Date: Jun. 16, 2011

(54) ADDITIVISING POLYMER POWDERS

(75) Inventors: LOUIS FOUARGE, Dilbeek (BE); Leo D'Hooghe, Kapellen (BE); Marjan Sillis, Edegem (BE)

(73) Assignee: TOTAL PETROCHEMICALS RESEARCH FELUY, Seneffe (BE)

(21) Appl. No.: 13/014,859

(22) Filed: Jan. 27, 2011

Related U.S. Application Data
(62) Division of application No. 11/501,177, filed on Nov. 3, 2008.

(30) Foreign Application Priority Data
Feb. 13, 2004 (EP) 04100591.9

(51) Int. Cl. C08L 23/06; C08L 23/02

(52) U.S. Cl. 524/585; 524/570

(57) ABSTRACT

The invention provides an apparatus for introducing additives onto a polymer powder.

It also provides a method for introducing an additive into a polyolefin powder, which method comprises the following steps:
(a) adding the additive in a solvent to form a solution; and
(b) introducing the solution to the polymer powder at a temperature of 60° C. or more,
   wherein, the solution is introduced to the polymer powder by spraying via a heated spraying means.

The present invention concerns an improved method for introducing additives into a polymer powder or fluff, and in particular into polyethylene powder. The method is advantageous, since it is capable of introducing the additives in a homogeneous manner throughout the polymer powder without the need for processing the powder through an extruder. The invention also covers the device that was used to implement said method.

For many years it has been known to introduce additives into polymers, such as polyethylene and polypropylene, in order to improve the properties of the polymers. Additives may impart many different advantageous effects to the polymers. Typical additives include additives for protection against UV radiation, anti-corrosion additives, and anti-oxidant additives. Generally the simplest method for introducing these additives into the polymers has been to extrude the polymer in the presence of the additives. The extrusion process causes melting of the polymer, and as the molten or softened polymer is extruded through a die, the additives become evenly mixed through the polymer volume, leading to generally homogeneous distribution of the additives throughout the extruded pelletised product.

Although the majority of polyethylene and polypropylene, and other similar polymers, sold on the market is delivered in an extruded pellet form, this is not appropriate for all applications. For some applications, a powder or fluff form of product is preferable, for example in the case of high molecular weight resins which are difficult to extrude, or where extrusion would cause degradation. Due to the nature of the manufacturing process, polymers are typically obtained in powder form from a reactor. It is this powder that is introduced into an extruder with the required additives. However, if the powder is to be sold unextruded, the problem arises of how to introduce the required additives without an extrusion procedure.

In the past, attempts have been made to solve this problem by blending the powder with the additives in solid form, or by dissolving the additives in a solvent such as a C₁₂ fraction, at around 40° C., and then adding the solution to the powder. These attempts have met with limited success. Blending the additives with the powder in solid form does not allow sufficiently homogeneous incorporation of the additives. Employing a solvent may improve homogeneity. However, many additives are not soluble in appropriate solvents and cannot be introduced in this manner. Increasing the temperature of the solvent has not been thought to be a solution to this problem in the past, since sparingly soluble additives would tend to precipitate out of solution at cold spots in the system, causing blockages. This in turn would lead to process shutdown, rendering the process economically non-viable.

It is an aim of the present invention to solve the problems associated with known methods, as discussed above. Thus, the present invention seeks to provide an improved method and apparatus for introducing additives into a polymer powder or fluff, and in particular into polyethylene or polypropylene powder.

Accordingly, the present invention provides a method for introducing an additive onto a polyolefin powder, which method comprises the following steps:
(a) adding the one or more additive(s) in a solvent;
(b) heating mixture (a) to a temperature of at least 60° C. in order to completely dissolve the one or more additive(s);
(b) introducing the heated solution (b) onto the polymer powder
   wherein, the solution is introduced onto the polymer powder by spraying via a heated spraying means.

In the context of the present invention, powder means any form of the polymer that is in a particulate form and has not been extruded. The particles of polymer may be of any size normally produced in an industrial manufacturing process. Typically the particles are produced by sedimentation into a settling leg of a polymerisation reactor. These particles are often termed fluff. Generally such fluff particles range in size and are 1600 □m or less in diameter. Preferably they are 1500 □m or less in diameter, and more preferably from 10 □m to 1000 □m in diameter. Most preferably the particles range from 100-1000 □m in diameter. The mean particle diameter for monomodal polymer is preferably 300 □m or greater, whilst for bimodal polymer it is preferably 125 □m or greater. Typical powder particle size distributions for monomodal and bimodal polymers respectively are provided in Table 1 and Table 2.

TABLE 1
Typical powder particle size distribution for a monomodal polyethylene

| Size grains | Percentage |
|---|---|
| (microns) | (wt %) |
| 0-63 | 0.1-3 |
| <125 | 1.5-4 |
| <250 | 2-10 |
| <500 | 10-55 |
| <1000 | 42-99 |
| <1600 | 95-100 |

TABLE 2
Typical powder particle size distribution for a bimodal polyethylene

| Size Grains | Percentage |
|---|---|
| (microns) | (wt %) |
| 0-63 | 0.4-12 |
| <125 | 3-40 |
| <250 | 7-83 |
| <500 | 24-99 |
| <1000 | 87-100 |
| <1600 | 95-100 |

The characteristic properties of the polymer are not especially limited, but generally it is a high density polymer. Preferably the polymer has a specific gravity of from 920-970 kgm⁻³ in the case of a monomodal polymer, and from 920-965 kgm⁻³ in the case of a bimodal polymer. Preferably the polymer has a bulk density of from 380-520 kgm⁻³ in the case of a monomodal polymer, and from 280-470 kgm⁻³ in the case of a bimodal polymer. The melt index of the polymer is not especially limited, but preferably in the case of a monomodal polymer, the melt index (2.16 kg at 190° C.) ranges from 0.05-2.0 g/10 mins, and in the case of a bimodal polymer from 0.03-60.0 g/10 mins. In the case of a monomodal or bimodal polymer, it is preferred that the specific heat capacity ranges from 0.40 kcal/kg° C. at 20° C. to 0.55 kcal/kg° C. at 100° C.

This invention is particularly suited to powder having these characteristics, especially polyethylene powder having the above characteristics.

The method of the present invention is particularly advantageous, since it allows larger quantities and varieties of additives to be introduced into polymer powders, without the need to extrude the powder. Blockage of the system, which is known to be a difficult problem for high temperature processes where the solvent is likely to be subject to large temperature fluctuations at some points in the system, may be avoided by maintaining circulation of the solution in the system at a sufficiently high flow rate to impede precipitation of the additives. In particular, blockage is also avoided by heating the spraying means, which would otherwise be a likely point for precipitation and blockage to occur.

The present invention will now be described in more detail by way of example only, by reference to the following Figures, in which:

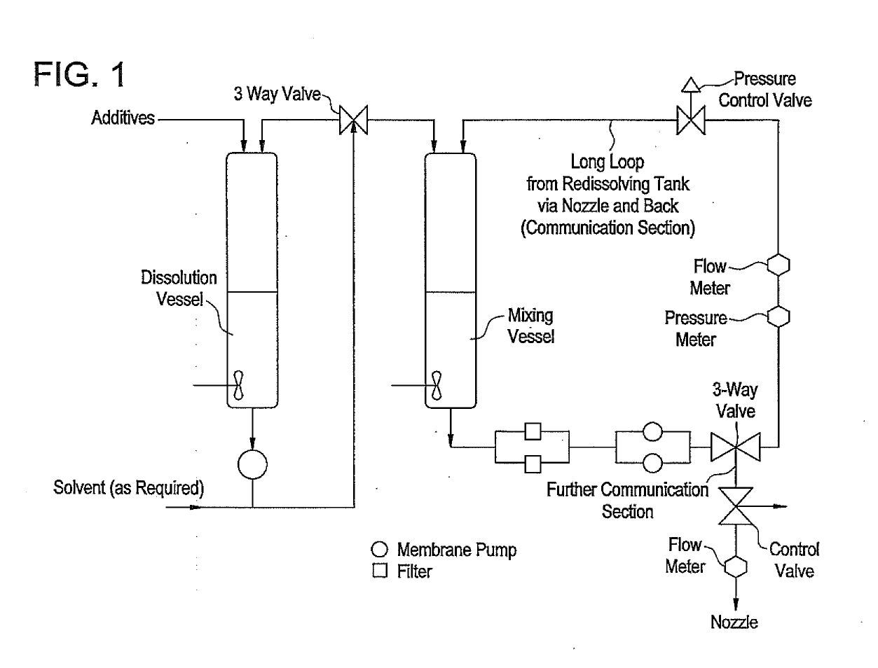

FIG. 1 shows an exemplary apparatus of the present invention, detailing the vessels for dissolving the additives, the parallel pumps and filters, the nozzle for spraying and the long communication loop for maintaining circulation of the additive solution; and

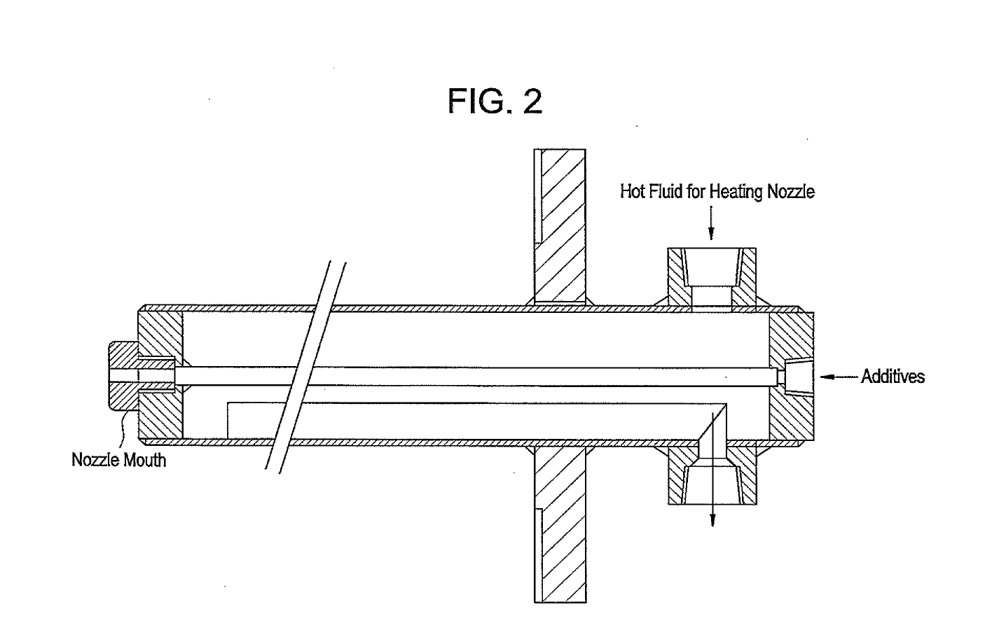

FIG. 2 shows a cross-section of a heated nozzle for spraying the additives onto the polymer product—hot fluid is directed around a central portion through which the additive solution is fed to the nozzle mouth for spraying.

To put the present method in context, a typical process for producing the polymer powder will first be described. Such a process generally employs a turbulent flow reactor such as a continuous pipe reactor in the form of a loop. However, other types of reactors such as stirred reactors may be used.

Polymerisation is carried out in a loop reactor in a circulating turbulent flow. A so-called loop reactor is well known and is described in the Encyclopaedia of Chemical Technology, 3^{rd} edition, vol. 16 page 390. This can produce LLDPE (linear low density polyethylene) and HDPE (high density polyethylene) resins in the same type of equipment. A loop reactor may be connected in parallel or in series to one or more further reactors, such as another loop reactor. A loop reactor that is connected in series or in parallel to another loop reactor may be referred to as a “double loop” reactor.

In the double loop reactor according to the present invention, the process is a continuous process. A monomer (e.g. ethylene) polymerises in a liquid diluent (e.g. isobutene) in the presence of a comonomer (e.g. hexene), hydrogen, catalyst, and activating agent The slurry is maintained in circulation by an axial pump consisting in a reactor essentially of vertical jacketed pipe sections connected by trough elbows. The polymerisation heat is extracted by a water cooling jacket. The reactor line includes two double loop reactors that can be used in parallel or in series. The approximate volume of the reactors may be about 100 m³. Monomodal grades are produced with the parallel or series configuration and bimodal grades are produced with the series configuration.

The product (e.g. polyethylene) is taken out of the reactor with some diluent through settling legs and discontinuous discharge valves. A small fraction of the total circulating flow is withdrawn. It is moved to a polymer degassing section in which the solid content is increased.

While being depressurised, the slurry is transferred through heated flash lines to a flash tank. In the flash tank, the product and diluent are separated. The degassing is completed in a purge column. A conveyor drying unit may be employed before the purge column in some instances

The powder product transported under nitrogen to fluff silos may remain as fluff and be additivised in accordance with the present invention, or may be extruded into pellets along with some specific additives. A pellet treatment unit comprising silos and hot and cool air flows allows the removal of residual components from the pellets. The pellets then are directed to homogenisation silos before final storage.

The gas exiting the flash tank and the purge column is treated in a distillation section. This allows the separate recovery of diluent, monomer and comonomer.

This embodiment of the double loop reactor process is usable with chromium type, Ziegler-Natta type or metallocene type catalysts. Each catalyst type may have a specific injection system.

It will be seen from the above that the present invention relates to the additivation of the polymer at the end of the exemplary production process.

In the present invention, it is preferred that the temperature of the solution is at 60° C. or higher when added to the polymer powder. Typically the temperature may be in the range of from 60° C. up to the flashpoint of the solvent being employed, for safety reasons. More preferably the temperature may be from 60-160° C., or 100-120° C. Typically the process is carried out at around 110° C. in most cases.

The solvent employed is not especially limited, provided that it does not adversely affect the polymer product. Typically the solvent comprises a hydrocarbon fraction Cₙ, wherein n is an integer of 4-24. More preferably n is an integer of from 6-18 and most preferably an integer of from 8-14. Typically the solvent employed is a C₁₂ fraction, but dodecane or isododecane may be added to the fraction if desired. Similarly other solvents may be added to the other preferred solvent fractions, if desired.

The additive employed is not especially limited, and may comprise any additive useful for improving the properties of the polymer. Generally the additive comprises one or more of an anti-oxidant, an anti-corrosive agent and a UV protective agent.

Typically, antioxidant additives include BHT, DLTDP and Irganox 1076. Preferably, the anti-UV additive includes Chimasorb 944 LD.

In a preferred embodiment, the method is carried out using a nozzle as a spraying means. The nozzle is not especially limited provided that it can withstand the solution and the heating involved in the method. Typically the spraying means is heated to a temperature at or above the temperature of the solution, although in some embodiments the spraying means may be heated to a lower temperature, depending on the solubility of the additives in the solvent employed.

The method of the present invention may be applied to any polymer powder, but typically polyolefin powders are preferred. In the most preferred embodiments the polymer powder is selected from polyethylene powder and polypropylene powder, with polyethylene powder being the most preferred.

In a process for producing polyolefins, a conveyor is often employed for drying the polymer powder after it has been removed from a reaction vessel. Often a purge column is employed after the conveyor dryer to complete the drying process. In some embodiments, the solution may be introduced to the polymer powder by spraying onto the powder on the conveyor. Alternatively the solution may be sprayed into a mixer on the powder if desired. In preferred embodiments, the method includes a further step of removing the solvent from the polymer powder after spraying, preferably using a purge column.

The present invention also provides an apparatus for introducing an additive into a polyolefin powder, which apparatus comprises the following elements:
(a) a dissolution vessel for dissolving the additive in a solvent to form a solution;
(b) a heated spraying means for introducing the solution to the polymer powder; and
(c) a communicating section connecting the dissolution vessel to the heated spraying means;
   wherein, between the dissolution vessel and the spraying means are situated at least two filters in parallel formation for removing solids from the communicating section, and at least two pumps in parallel formation for pumping the solution through the communicating section to the heated spraying means.

In the apparatus of the invention, the parallel formation of the filters and the pumps allows one of each to be removed from the system for servicing without the requirement for shutting down the production process. This is important in the present process, since precipitation of the additives can occur and block the system if it is not properly maintained. Furthermore, maintaining circulation in both pumps and both filters, except when in maintenance, prevents precipitation in these components and reduces the requirement for servicing.

Preferably, the communicating section comprises a loop extending from an exit port in the dissolution vessel to an entry port in the dissolution vessel, and the heated spraying means is connected to the loop via a further communication section downstream from the filters and the pumps, via a three-way valve. The purpose of the loop is to allow circulation of the solution around the system at all times, even when spraying ceases. Typically, the flow rate of the solution through the communication section is maintained at a rate sufficiently high to prevent precipitation of the additive in the communication section, which may occur due to temperature reduction. When the flow rate of the solution through the communication section is maintained at a high rate the further communication section preferably comprises a control valve to reduce the flow rate of the solution into the heated spraying means. This ensures that the pressure of the solution at the point of spraying is not too high. The communication section, and the further communication section, preferably comprise flow meters for monitoring the flow rate in each section. It is further preferred that there is a pressure meter in the communication section to monitor the pressure in that section. This is to ensure that the pressure is sufficient for proper functioning of the control valve in the further communication section. Typically the further communication section is very much shorter than the communication section. This is to allow easier maintenance of this section, should any blockage occur.

In a preferred embodiment a mixing vessel may be employed in place of the dissolution vessel. The mixing vessel receives the return from the loop and has an exit port for introducing the solution from the vessel into the communication section, in the same way as the dissolution vessel. However, in this embodiment dissolution takes place outside of the main section of the loop, avoiding the need to expose any part of the communication section or the loop to solid additives or fresh solvent. In this embodiment, the dissolution vessel is used to create the solution, which is then fed into the mixing vessel.

If desired, fresh solvent may be introduced via a valve to any part of the system. Preferably the apparatus is arranged such that fresh solvent may be added to the line feeding the solution from the dissolution vessel to the mixing vessel.

It is also preferred that a membrane pump is employed to feed the solution from the dissolution vessel to the mixing vessel. The parallel pumps are also preferably membrane pumps.

The present invention will now be described in more detail by way of example only, by reference to the following specific embodiments.

### EXAMPLES

The operation of a typical device for additivising a polymer product according to the present invention is outlined below.

FIG. 1 shows a typical apparatus of the present invention for additivising polymer fluff product. Additives are introduced into the dissolution vessel, along with solvent. The solution is heated and stirred as necessary until all of the additives have dissolved. The additive solution is taken from the dissolution vessel and pumped via a membrane pump into the long loop communication section, which leads into the mixing vessel. Solvent may also be added via this feed, if more solvent becomes necessary. The additive solution is kept in circulation within the communication loop at a sufficient flow rate to ensure that precipitation does not occur. The mixing vessel also helps to ensure that any solids that might form are quickly dissolved once again. The pressure meter and flow meter in the loop ensure that the required flow is maintained. Parallel membrane pumps propel the fluid around the loop, whilst parallel filters ensure that any solids are removed from the loop. These pumps and filters can be serviced without switching the system off, since the parallel arrangement allows one pump or filter to be serviced whilst the remaining one is still operational. A further short communication section attaches the loop to the nozzle via a three way valve. The additive solution is fed down this line from the loop and through a control valve, which reduces the pressure at the nozzle to a level appropriate for spraying. The additive solution is then sprayed directly onto the polymer fluff.

The nozzle is heated to ensure that blockages do not occur. A nozzle adapted for use with the present invention is depicted in FIG. 2.

As discussed above, the additive is added as an additive composition in solution. Examples of additive solutions that may be employed in the present invention include the following:
1. BHT, 9 wt. %; DLTDP, 13 wt. %; Irganox 1076, 18 wt. %; and Isododecane solvent, 60 wt. %
2. Irganox 1076, 30 wt. %; Chimasorb 944 LD, 25 wt. %; and Isododecane solvent, 45 wt. %

All of these example additive compositions may be employed in the protocol described above. The above solutions are particularly effective for additivising polyethylene fluff and polypropylene fluff.

1-13. (canceled)

14. A method for introducing an additive into contact with a polyolefin powder comprising:
a) providing a hydrocarbon solvent;
b) adding an additive into said hydrocarbon solvent and heating the mixture of said additive and said hydrocarbon solvent to a temperature of at least 60° C. to dissolve the additive in said hydrocarbon solvent; and
c) introducing the heated solution into contact with a polyolefin powder by supplying said solution into a spraying section which is heated and which is provided with a nozzle for spraying said solution from said spraying section.

15. The method of claim 14, wherein said hydrocarbon solvent is a C₆-C₁₈ is hydrocarbon.

16. The method of claim 14, wherein said hydrocarbon solvent is a C₈-C₁₄ hydrocarbon.

17. The method of claim 14, wherein said hydrocarbon solvent is a C₁₂ hydrocarbon.

18. The method of claim 14, Wherein said hydrocarbon solvent is heated to a temperature within the range of 100°-120° C.

19. The method of claim 14, further comprising subsequent to the addition of additive solution to said polyolefin powder removing at least a portion bf the hydrocarbon solvent from said powder.

20. The method of claim 14, wherein said additive is selected from the group consisting of an antioxidant agent, an anticorrosive agent, and a uv protective agent, and mixtures thereof.

21. The method of claim 14, wherein the said polyolefin powder is a polyethylene powder or a polypropylene powder.

22. The method of claim 21, wherein said polyolefin powder is a polyethylene powder.

23. The method of claim 22, wherein said solvent is a C₆-C₁₈ hydrocarbon.

24. The method of claim 23, wherein said hydrocarbon solvent is a C₈-C₁₄ hydrocarbon solvent.

25. The method of claim 24, wherein said hydrocarbon solvent is a C₁₂ hydrocarbon.

26. The method of claim 23, wherein said hydrocarbon solvent is heated to a temperature within the range of 100°-120° C.

27. The method of claim 23, wherein said additive is selected from a group consisting of an antioxidant agent, an anticorrosive agent, and a uv protective agent, and mixtures thereof.

28. The method of claim 27, further comprising subsequent to the addition of said additive solution to said polyolefin powder removing at least a portion of the hydrocarbon solvent from said powder.
